(19) United States
(12) Patent Application Publication
(10) Pub. No.: US 2006/0241537 A1
(43) Pub. Date: Oct. 26, 2006

(54) Handheld palm acupressure apparatus

(76) Inventor: Chin Chia Liu, Tustin, CA (US)

Correspondence Address: Chin Chia Liu, 275 E. 6th Street, #120, Tustin, CA, 92780, US

(21) Appl. No.: 11/129,890

(22) Filed: May 16, 2005

(30) Foreign Application Priority Data
Apr. 26, 2005 (TW) 94206548

(51) Int. Cl. A61H 15/00

(52) U.S. Cl. 601/118; 606/204

(57) ABSTRACT

The invention discloses a handheld palm acupressure apparatus comprising a base body having a plurality of protuberances with rolling features that are configured with rolling pressure enabling for compressing against acupressure points of the palm or other part of the body for physical therapy purposes.

### FIELD OF THE INVENTION

The present invention generally relates to a palm acupressure massaging apparatus and methods of use. More particularly, the present invention relates to a handheld palm acupressure apparatus with rolling features for compressing against the palm, finger or other body part creating pressure stimulating effects for physical therapy purposes.

### BACKGROUND OF THE INVENTION

Acupressure is a form of treatment for various conditions and maladies. It was generally believed that there are patterns of energy flow through the palm that are essential for proper health maintenance. Imbalance or disruption of energy flow through any of these patterns is believed to be responsible for diseases. The energy flow patterns through the body have been mapped extensively and there are substantial numbers of acupressure points, called “sheh” herein, along the flow patterns where the energy flow is close to the skin surface. In one aspect, acupressure is to apply stimulation or pressure at the “sheh” points to modulate the flow of energy and modify the dynamics in the energy flow. When done properly, acupressure therapy enhances body immunity so as to mitigate diseases, rejuvenates the blood flow and restores health.

Acupressure therapy is a simple inexpensive technique, with virtually no negative side effects, that could greatly enhance the treatment of many health conditions if it were readily available to the lay public. Acupressure is a direct offshoot of acupuncture wherein one or more known points on the surface of the skin receive pressure instead of having a needle inserted. The concept remains the same. It is to re-institute balanced energy flow as treatment of a malady caused by an imbalance in the energy flow through the body. Western medical research has also shown physiological effects, including reflexes and neurohumoral effects of acupuncture and acupressure in human subjects.

The benefits of massage and acupressure have been known for centuries. Massage as a form of therapy has been used by almost all cultures for thousands of years, dating back to the ancient Greeks and Romans where Hippocrates extolled its virtues as a form of medical treatment. Acupressure is a specific type of massage, dating back over 5,000 years in ancient China. The technique consists of applying localized pressure to specific acupressure points (that is, “sheh” as defined herein) on the body as opposed to acupuncture which inserts needles into these same points. The effects of acupressure and acupuncture are similar. Studies have demonstrated that acupuncture stimulates the nervous system, causing alterations in the amount of neurotransmitters and/or neurohormones released, thus resulting in changes in blood flow, immune function and/or pain perception. The effects of massage and acupressure such as reduction in pain, muscle tension and stress are well documented.

Thus, various acupressure palm apparatuses have been disclosed for massaging and stimulating the palm of a patient. Examples are Taiwan Patent Publication No. 128962, entitled “Palm Acupressure Apparatus”, Taiwan Patent Publication No. 289255, entitled “Palm Acupressure Ball”, Taiwan Patent Publication No. 302694, entitled “Palm Acupressure Apparatus”, and Taiwan Patent Publication No. 485812, entitled “Palm Utility Acupressure Ball”. Among them, the No. 485812 patent is bulky which is suitable for uses in a hospital or a clinic only.

Each of the above-cited patents discloses some palm acupressure apparatuses having conventional structure with some incremental improvement in features and utility. They are configured with structural differences for uses in various occasions. Furthermore, the prior art apparatus utilizes palm acupressure with simple physical therapy without rolling effects. What is needed is an improved apparatus with acupressure capability and rolling features enabling both pressing and massaging effects, which are not disclosed in any of the prior art.

### SUMMARY OF THE INVENTION

It is one object of the present invention to provide a palm acupressure stimulating apparatus to overcome the disadvantages of the conventional prior art devices.

It is another object of the present invention to provide a handheld palm acupressure apparatus with rolling features for compressing against a palm, the palm muscle, fingers, and other body parts enabling pressure stimulating effects for physical therapy purposes.

A co-pending application, U.S. patent application Ser. No. 10/865,971, filed on Jun. 11, 2004, entire contents of which are incorporated herein by reference, discloses a hand-paddle type palm acupressure apparatus worn by a user on his hand configured with acupressure therapy by intermittently pressing the apparatus against a body part.

A co-pending application, U.S. patent application Ser. No. 10/924,608, filed on Aug. 23, 2004, entire contents of which are incorporated herein by reference, discloses a handheld finger acupressure apparatus for compressing against fingers or the palm muscle creating pressure stimulating effects for physical therapy purposes.

Some aspects of the invention relate to a palm acupressure apparatus comprising: an elongate strap with two ends; and an axially symmetric base body having an external surface and a grooved enclosure space therewithin, the surface being configured with a plurality of spaced apart protuberances, the grooved enclosure space being configured for holding the two ends of the strap, wherein the base body is freely rotatable with respect to an axial line of the base body.

Some aspects of the invention relate to a handheld palm acupressure apparatus comprising: an axially symmetric base body with two ends and an external surface, the surface being configured with a plurality of protuberances, wherein the base body is freely rotatable with respect to an axial line of the base body; and an adjustable strap secured to the two ends of the base body, the strap being sized and configured so as to be held by a hand.

Some aspects of the invention relate to a method of enhanced physical therapy comprising: providing a handheld palm acupressure apparatus having rolling features; and applying a rolling pressure with the handheld palm acupressure apparatus to a body part enabling compressing against the body part for enhanced physical therapy.

### BRIEF DESCRIPTION OF THE DRAWINGS

Further features and advantages of the present invention will become apparent to one of skill in the art in view of the Detailed Description of Exemplary Embodiments that follows, when considered together with the attached drawings and claims.

FIG. 1A shows a perspective view of one embodiment for a palm acupressure apparatus according to the principles of the present invention.

FIG. 1B shows a perspective view of another embodiment for a palm acupressure apparatus according to the principles of the present invention.

FIG. 2 shows an exploded perspective view of the palm acupressure apparatus of FIG. 1A.

FIG. 3A shows a cross-sectional view of the palm acupressure apparatus of FIG. 1A.

FIG. 3B shows a portion of the apparatus of FIG. 3A, illustrating means for adjusting the length of the strap to the base body.

FIG. 4 shows one embodiment of the enabling strap structure.

FIG. 5 shows a perspective view of the apparatus of FIG. 3A, illustrating means for removably mounting the stimulating element onto a body holder.

FIG. 6 shows another embodiment of the apparatus of FIG. 3A, illustrating means for securing two stimulating members to form a base body.

FIG. 7A shows one embodiment of means for operating a palm acupressure apparatus of the present invention for massaging the backside of a hand.

FIG. 7B shows another embodiment of means for operating a palm acupressure apparatus of the present invention for massaging fingers.

FIG. 8A shows one embodiment of means for operating a palm acupressure apparatus of the present invention for massaging the back of a finger.

FIG. 8B shows another embodiment of means for operating a palm acupressure apparatus of the present invention for massaging a leg.

### DETAILED DESCRIPTION OF EXEMPLARY EMBODIMENTS

Preferred embodiments of the present invention described below relate particularly to a handheld palm acupressure apparatus comprising rolling features for applying rolling pressure to the human body, rather than a sliding or frictional engagement for physical therapy purposes. While the description sets forth various embodiment specific details, it will be appreciated that the description is illustrative only and should not be construed in any way as limiting the invention. Furthermore, various applications of the invention, and modifications thereto, which may occur to those who are skilled in the art, are also encompassed by the general concepts described below.

The “sheh” is herein intended to mean a point along the flow patterns where the energy flow is close to the skin surface. In one aspect, acupressure is to apply pressure and stimulation at the “sheh” point to modulate the flow of energy and modify the dynamics in the energy flow.

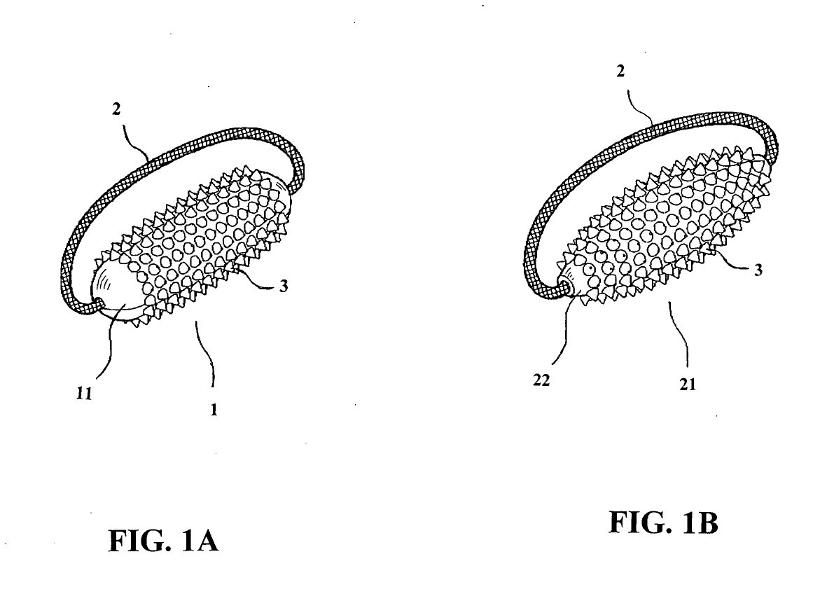

Referring to FIGS. 1-8, what is shown is an embodiment comprising a palm acupressure apparatus 1 having a length and diameter such that the apparatus can conveniently be grasped by the operator. According to a preferred aspect of the invention, a base body 11 comprises a roller member with a plurality of protuberances 3 mounted thereon; the roller member has an axis of rotation in substantial axial alignment with respect to the longitudinal axis of the base body. The roller member has a cylindrical configuration (as shown in FIG. 1A) or olive-like configuration (as shown in FIG. 1B). The anchoring member 4 of the retention strap 2 is retained within the base body by closing the open mouth of the grooved enclosure to form a retaining flange or knot. In one embodiment, the base body comprises a plurality of protuberances each having a base end attached to a resilient or rigid medium and a point end for applying pressure to tissue without cutting or penetrating the skin or tissue.

Since the roller member is freely rotatable with respect to an axial line of the base body, the roller member may be applied to “sheh” (that is, acupressure points) and gently moved back and forth over the points during therapy.

In one embodiment, a palm acupressure apparatus 11 (or 22 shown in FIG. 1B) comprising a base body 1 (or 21 shown in FIG. 1B) with an external surface, wherein at least a portion of the external surface of the base body is mounted or configured with a plurality of stimulating units (also known as protuberances) 3. In one embodiment, the base body comprises a grooved enclosure space 12 configured for receiving the anchoring member 4 of a retention strap 2. There is one exit opening 16 at each end of the base body along the axial line thereon, wherein the opening is in communication with the enclosure space allowing for inserting one end of the retention strap 2. The anchoring member 4 further comprises a central hole 41 sized and configured allowing the end of the retention strap to pass through and be secured at a distal side of the central hole, for example by forming a knot.

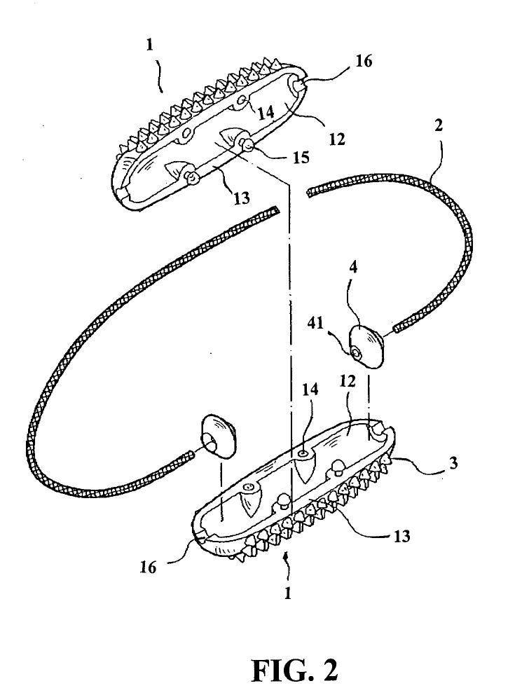

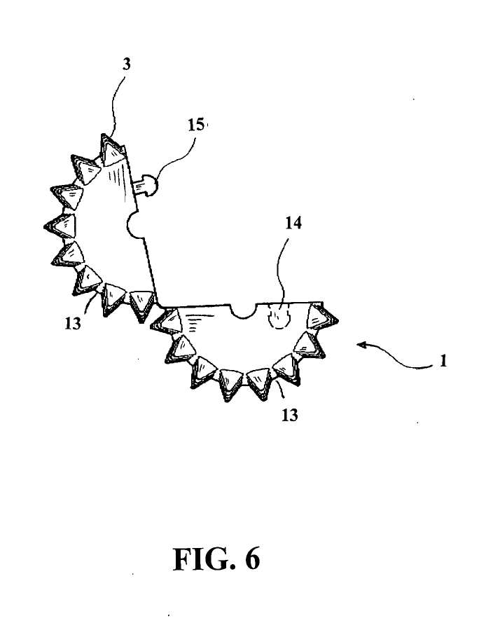

FIG. 6 shows a cross-sectional view of another embodiment of the apparatus of the present invention, illustrating means for securing two stimulating members 13 to form a base body, each member having a plurality of protuberances. In one embodiment, the base body comprises two essentially symmetrical parts 13 (FIG. 2) that can properly match against each other to form the base body that is rotatable with respect to an axial line of the base body. In one embodiment, the peripheral edge of each part 13 comprises a plurality of anchoring buttons 15 and a plurality of matching anchoring slots 14; each slot is dimensioned and configured for properly receiving its corresponding anchoring button. In one embodiment, an anchoring button 15 may have a narrowed neck and an enlarged flexible end zone (for example, like a peanut) for snugly inserting into its matching slot 14 that has a properly sized narrowed neck and enlarged bottom.

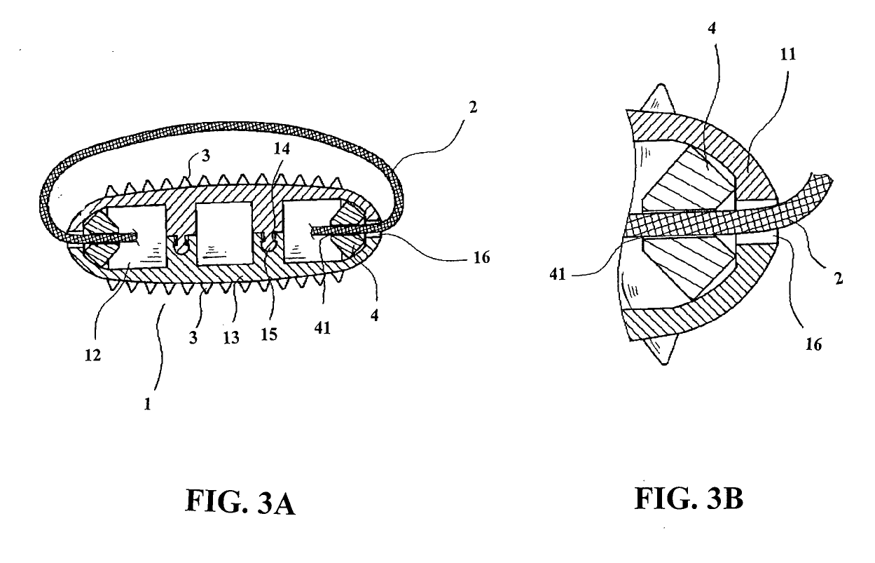

After both ends of the retention strap 2 are secured into the enclosure space 12, the length of the retention strap can be adjusted according to the need of a user. In one embodiment, the strap may comprise two sections that are securable with Velcro hook-and-hoop type mechanisms. In another embodiment, the retention strap can be a single elastic strap that is snugly held by a hand. As shown in FIGS. 3A and 3B, the anchoring member 4 forms a point or line contact with at least a portion of the edges of the enclosure space 12 and is freely movable within the space 12. In one preferred embodiment, the anchoring member 4 as shown in FIG. 3B is sized and configured to tightly squeeze and hold the retention strap when the strap is pulled outwardly away from the opening 16.

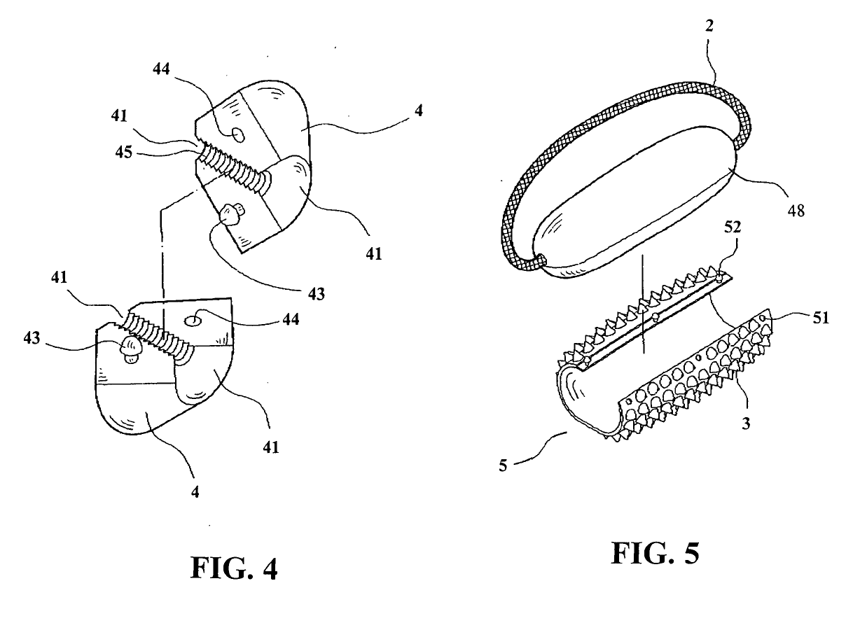

FIG. 4 shows one preferred embodiment of a strap structure 2. In one embodiment, the anchoring member 4 of the strap comprises a central hole 41 that has a screw line 45 enabling secured holding of the end portion (having a marching screw feature) of the strap within the enclosure 12. In a further embodiment, the anchoring member 4 further comprises at least a set of matching male-female type button and slot 43, 44 for more secured anchoring.

FIG. 5 shows a perspective view of the apparatus of the present invention, illustrating means for removably mounting a rolling sheet 5 onto a body holder 48 configured to form a base body with protuberances. Different rolling sheets with a variety of protuberances can be mounted onto the body holder to fit any specific purposes. In one embodiment, the rolling sheet is equipped and configured with at least one set of matching male-female type securing button and slot 51, 52 at their edges for securely mounting the sheet onto the body holder.

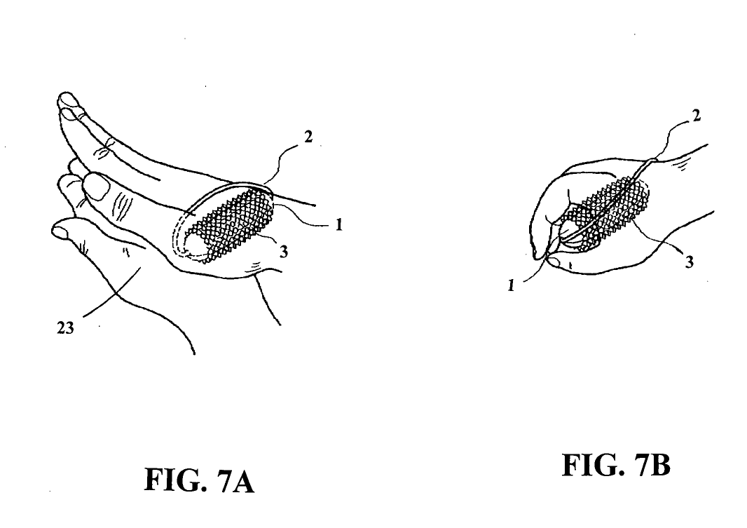

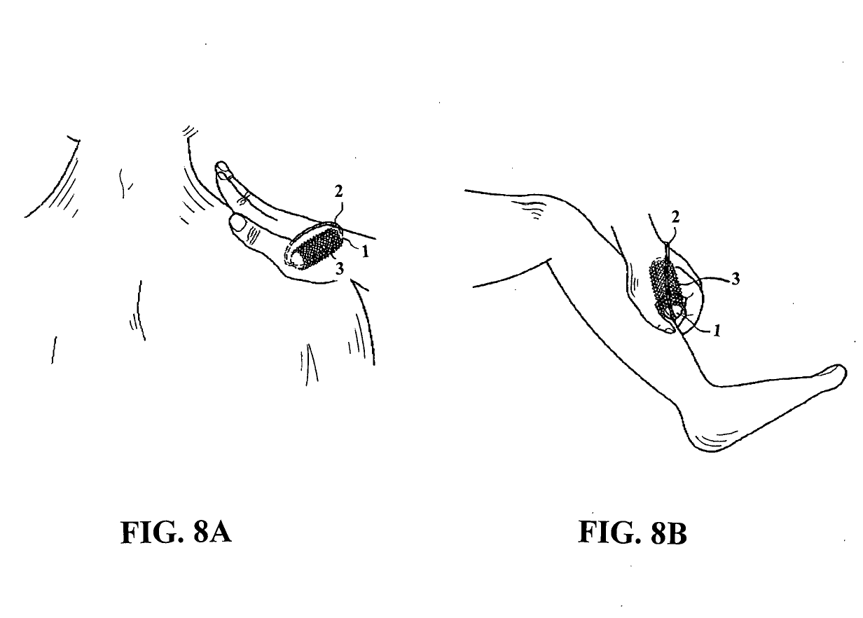

FIGS. 7A-8B show a variety of means for operating a palm acupressure apparatus of the present invention for massaging the backside of a hand, a finger, back of a finger, a leg, a palm 23 and the like. As disclosed, the palm acupressure apparatus of the present invention can also be used to massage, but not limited to, a neck, a shoulder, a body part, and combination thereof with rolling pressure.

The point end of the protuberances or stimulating units may be a round, conical, blunt or other shape according to the need of an individual. In one embodiment, the length of the protuberances is sized, spaced, and configured to fit the need and the contours of the individual's palm or other body parts. By way of examples in one embodiment, all the protuberance height (that is, length) of all protuberances is about equal on an olive-shaped base body so as to intimately contact most of the “sheh” points with a rolling feature for stimulation and massage. In one embodiment, the protuberances are constructed with an essentially semi-rigid or rigid material and sized to apply appropriate pressure against the muscle skin or “sheh”. The protuberances are also sufficiently spaced apart and configured to impart appropriate pressure at about the clusters of “sheh” on the fingers or the palm of an individual. In one embodiment, the protuberances are substantially perpendicular to the axial line of the base body.

Some aspects of the invention relate to a palm acupressure apparatus comprising: an elongate strap with two ends; and an axially symmetric base body having an external surface and a grooved enclosure space therewithin, the surface being configured with a plurality of spaced apart protuberances, the grooved enclosure space being configured for holding the two ends of the strap, wherein the base body is freely rotatable with respect to an axial line of the base body. In one embodiment, the strap is secured to the two ends of the base body, the strap being adjustable, sized and configured so as to be held by a hand.

From the foregoing description, it will be appreciated that a palm acupressure apparatus comprising roller features for applying rolling pressure to the human body has been disclosed. While aspects of the invention have been described with reference to specific embodiments, the description is illustrative and is not intended to limit the scope of the invention. Various modifications and applications of the invention may occur to those who are skilled in the art, without departing from the true spirit or scope of the invention. The breadth and scope of the invention should be defined only in accordance with the appended claims and their equivalents.

1. A palm acupressure apparatus comprising: an elongate elastic strap with two ends; and an axially symmetric base body in an olive-like configuration having an external surface and a grooved enclosure space therewithin, said surface being configured with a plurality of spaced apart stimulating units, the base body being rotatable with respect to an axial line of the base body, wherein said elastic strap is adapted to exert force onto a distal end of said stimulating units of the olive-like base body for acupressure massage.

2. The palm acupressure apparatus according to claim 1, wherein said each end of the strap is equipped with an anchoring member to be securely held by said grooved enclosure space, each anchoring member further comprising a center hole.

3. The palm acupressure apparatus according to claim 2, wherein the anchoring member forms a point or line contact with at least a portion of edges of the grooved enclosure space.

4. The palm acupressure apparatus according to claim 2, wherein the anchoring member is configured freely movable within the grooved enclosure space.

5. The palm acupressure apparatus according to claim 1, wherein the anchoring member comprises a central hole that has a screw line enabling secure holding of an end portion of the strap within the grooved enclosure space.

6. (canceled)

7. The palm acupressure apparatus according to claim 1, wherein at least one axial end of the base body has an exit opening configured for inserting one end of the strap.

8. The palm acupressure apparatus according to claim 1, wherein the base body comprises a body holder and a rolling sheet with stimulating units that is removably mounted onto said body holder configured to form a base body with stimulating units.

9. The palm acupressure apparatus according to claim 1, wherein the base body comprises two substantially symmetrical parts that properly match against each other to form the base body.

10. The palm acupressure apparatus according to claim 9, wherein said two substantially symmetrical parts are securely matched with at least a pair of matching button and slot.

11. The palm acupressure apparatus according to claim 1, wherein said stimulating units have a base end and a point end, at least one stimulating unit comprising a conical point end.

12. The palm acupressure apparatus according to claim 1, wherein said stimulating units have a base end and a point end, at least one stimulating unit comprising a round point end.

13. The palm acupressure apparatus according to claim 1, wherein said stimulating units have a base end and a point end, at least one stimulating unit comprising a blunt point end.

14. The palm acupressure apparatus according to claim 1, wherein at least one stimulating unit is perpendicular to an axial line of the base body.

15. A handheld palm acupressure apparatus comprising: an axially symmetric base body in an olive-like configuration with two ends and an external surface, said surface being configured with a plurality of stimulating units, wherein said base body is rotatable with respect to an axial line of the base body; and an adjustable strap secured to said two ends of the base body, said strap being sized and configured so as to be held snugly by a hand, wherein said strap is adapted to exert force onto a distal end of said stimulating units of the olive-like base body for acupressure massage.

16. The handheld palm acupressure apparatus according to claim 15, wherein said stimulating units have a base end and a point end, at least one stimulating unit comprising a conical or round point end.

17. The handheld palm acupressure apparatus according to claim 15, wherein at least one stimulating unit is perpendicular to an axial line of the base body.

18. (canceled)

19. The handheld palm acupressure apparatus according to claim 15, wherein the base body comprises a body holder and a rolling sheet with stimulating units that is removably mounted onto said body holder configured to form a base body with stimulating units.

20. (canceled)
